(19) United States
(12) Patent Application Publication
(10) Pub. No.: US 2017/0329909 A1
(43) Pub. Date: Nov. 16, 2017

(54) METHODS, APPARATUSES AND COMPUTER PROGRAM PRODUCTS FOR MANAGING HEALTH CARE WORKFLOW INTERACTIONS WITH A SAVED STATE

(71) Applicant: Caradigm USA LLC, Bellevue, WA (US)

(72) Inventors: James Conti, Algonquin, IL (US); Corinne Pascale, Bellevue, WA (US); Adarsh Khare, Issaquah, WA (US); Kalpana Viswanathan, Sammamish, WA (US); Catherine Lazatin, Cambridge, MA (US); Jade Naaman, Bellevue, WA (US); VenkataChari SampathKumar, Sammamish, WA (US); Bhaskar Shankar Reddy, Bellevue, WA (US); Linda Walmer, Seattle, WA (US); Larry Nicklas, Renton, WA (US)

(21) Appl. No.: 15/608,521

(22) Filed: May 30, 2017

Related U.S. Application Data
(63) Continuation of application No. 15/294,331, filed on Oct. 14, 2016, now abandoned.
Application No. 15/294,331 is a continuation of application No. 13/782,783, filed on Mar. 1, 2013, now abandoned.

(51) Int. Cl. G06F 19/00; G06Q 10/06

(52) U.S. Cl. CPC G06F 19/327; G06Q 10/0633; G06F 19/3406

(57) ABSTRACT

An apparatus is provided for managing health care tasks. The apparatus may include at least one memory and at least one processor configured to display a user interface including a workspace area including visible indicia indicating steps of a health care task(s) to be performed on behalf of a patient(s) and a context area arranged adjacent to the workspace area. The context area includes visible information indicating health care data of the patient associated with visible indicia of the workspace area. The processor is also configured to update display of the visible indicia of the workspace area to include different health care data responsive to detecting a change in data of the visible indicia or updating display of the visible information of the context area to include different health care information responsive to detecting changes in information of the visible information. Corresponding computer program products and methods are also provided.

### TECHNOLOGICAL FIELD

Embodiments of the invention relate generally to a mechanism of facilitating user interaction with health care data and more particularly relate to a method, apparatus and computer program product for managing workspace interactions of health care data and automatically saving the state of health care data.

### BACKGROUND

Currently, the health care world is extremely interrupt driven. For instance, health care workers are frequently in the middle of an activity focused on a patient when the health care worker is interrupted and needs to answer a question regarding another patient. In this regard, the health care worker is typically forced to abandon their activity and either start a new activity or at the very least require a save action before the health care worker may leave a screen displaying the activity if the health care worker wants their entered data to be retained.

Additionally, health care workers may need ready access to clinical data while the health care workers are completing workflows. Typically, the health care workers are required to switch between multiple windows and even systems to manage their tasks, view relevant clinical and non-clinical data, and manage care for a patient.

At present, in the online retail space, for example, there is familiarity with websites that support an on-screen shopping cart experience, in which a user may view their cart contents while they navigate the website. However, these technologies typically require a user to click a button to populate an item to their cart and click save if making changes to the contents of the cart (e.g., sometimes for each item changed). However, these retail websites typically do not address the concept of saving data automatically for a user as they navigate between different form components.

In view of the foregoing drawbacks, it may be beneficial to provide an efficient and reliable mechanism of enabling navigation between activities in health care data while automatically saving current data and a state.

### BRIEF SUMMARY

A method, apparatus and computer program product are therefore provided that may provide an efficient and reliable mechanism for enabling navigation between activities in health care data to facilitate management of one or more tasks and automatically save current data and a state.

In this regard, the exemplary embodiments may automatically save data (e.g., a health care task(s)) as a health care clinician navigates between multiple different windows, different form components or the like to manage health care tasks associated with one or more patients.

The exemplary embodiments may provide a user interface that facilitates display of the steps of a workflow, or list of workflows, which may drive corresponding health care data shown in an adjacent context area. The workflow and context areas may support a pencil state in which data entered by a user (e.g., a health care clinician (e.g., a care manager)) may be automatically saved without requiring the user to click any buttons, menus, tabs or the like, or otherwise take any action.

In this regard, the exemplary embodiments may provide a user interface displaying a workflow area (also referred to herein as workspace area) and a related context area connected or linked to the workflow. The workflow area and the context area may interact with and drive each other. The exemplary embodiments may also enable quick access to a patient's clinical data while enabling a health care clinician to work on tasks related to care of the patient.

The exemplary embodiments may save data in a pencil state. For example, by saving data in a pencil state, a communication device of the exemplary embodiments may automatically save information entered by a user such as, for example, a health care clinician without requiring the user to perform any active action such as, for example, by clicking any buttons, menus or the like in order to have the information they have entered to be saved and stored. In some example embodiments, the pencil state may denote a state that is not committed to an official record. In some other example embodiments, a communication device may be configured to trace the origin of data left in a pencil state.

In some example embodiments, a communication device may detect an expiration of clinical data left in pencil state in response to a predetermined time period assigned to the clinical data elapsing. In this regard, the communication device may determine that the clinical data is stale or irrelevant and may delete the clinical data, or may notify a user (e.g., a health care clinician) that the clinical data expired and request an indication as to the manner in which to handle (e.g., retain, delete, etc.) the clinical data.

In one example embodiment, a method for managing health care data is provided. The method may include enabling display of a generated user interface including a workspace area including visible indicia indicating a plurality of steps of one or more health care tasks to be performed on behalf of at least one patient and a context area arranged adjacent to the workspace area. The context area may include visible information indicating health care data of the patient that is associated with the visible indicia of the workspace area. The method may further include updating display of the visible indicia of the workspace area to include different health care data in response to detecting a change in related data of the visible indicia of the context area or updating display of the visible information of the context area to include different health care information in response to detecting a change in related information of the visible information of the workspace area.

In another example embodiment, an apparatus for managing health care data is provided. The apparatus may include a processor and a memory including computer program code. The memory and computer program code are configured to, with the processor, cause the apparatus to at least perform operations including enabling display of a generated user interface including a workspace area including visible indicia indicating a plurality of steps of one or more health care tasks to be performed on behalf of at least one patient and a context area arranged adjacent to the workspace area. The context area may include visible information indicating health care data of the patient that is associated with the visible indicia of the workspace area. The memory and computer program code are also configured to, with the processor, cause the apparatus to update display of the visible indicia of the workspace area to include different health care data in response to detecting a change in related data of the visible indicia of the context area or updating display of the visible information of the context area to include different health care information in response to detecting a change in related information of the visible information of the workspace area.

In yet another example embodiment, a computer program product for managing health care data is provided. The computer program product includes at least one computer-readable storage medium having computer-executable program code instructions stored therein. The computer-executable program code instructions may include program code instructions configured to enable display of a generated user interface including a workspace area including visible indicia indicating a plurality of steps of one or more health care tasks to be performed on behalf of at least one patient and a context area arranged adjacent to the workspace area. The context area may include visible information indicating health care data of the patient that is associated with the visible indicia of the workspace area. The computer program product may further include program code instructions configured to update display of the visible indicia of the workspace area to include different health care data in response to detecting a change in related data of the visible indicia of the context area or updating display of the visible information of the context area to include different health care information in response to detecting a change in related information of the visible information of the workspace area.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a diagram of a display screen according to an exemplary embodiment of the invention;

FIG. 4 is a diagram of a user interface according to an exemplary embodiment of the invention;

FIGS. 5A-5D are diagrams illustrating other user interfaces for managing healthcare tasks of workflows according to other example embodiments of the invention;

FIG. 6 is a diagram illustrating a user interface with a saved state according to an exemplary embodiment of the invention; and

FIG. 7 is a flowchart of an exemplary method according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a workflow(s) may, but need not, denote a process for activities associated with performing one or more tasks (e.g., health care tasks). In this regard, for example, a workflow(s) may be a series of processing steps and visual forms that define the manner in which to perform a task(s) such as, for example, a patient assessment. Additionally, as referred to herein, health care data, health care information or the like may, but need not, denote clinical and non-clinical information of importance to a person's (e.g., a patient's) health. Clinical data may include, but is not limited to, vitals, diagnostics, lab data, prescriptions, etc. Non-clinical data may include, but is not limited to, a person's (e.g., a patient's) insurance or advanced directives and any other suitable data.

As referred to herein, a pencil state may, but need not, denote data input in a form, application, workflow, workspace area, context area or the like that is retained, stored and/or saved even without user interaction.

### General System Architecture

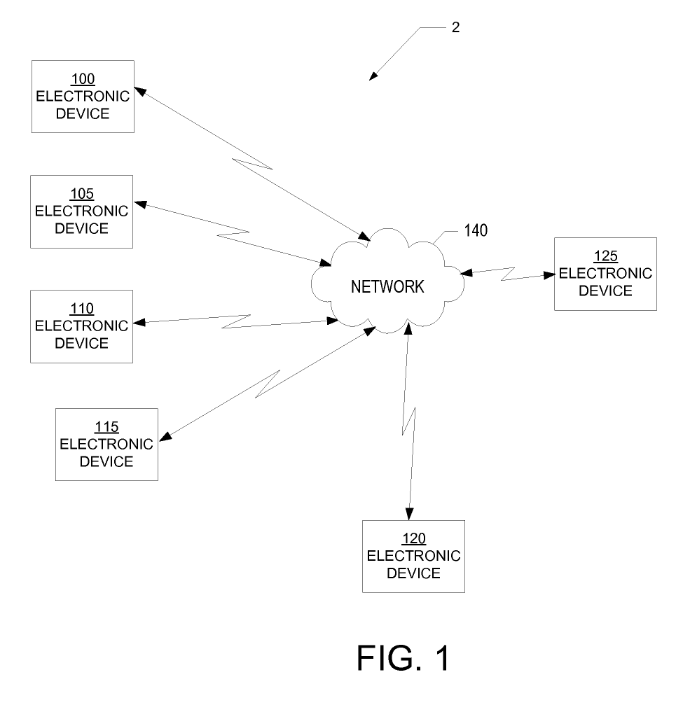

Reference is now made to FIG. 1, which is a block diagram of a system according to exemplary embodiments. As shown in FIG. 1, the system 2 (e.g., a health care system) may include one or more electronic devices 100, 105, 110, 1115, 120 and 125 (e.g., personal computers, laptops, workstations, servers, personal digital assistants, smart devices and the like, etc.) which may communicate with each other, over a network 140, such as a wired local area network (LAN) or a wireless local area network (WLAN), a metropolitan network (MAN) and/or a wide area network (WAN) (e.g., the Internet).

In one exemplary embodiment, the electronic devices 100, 105, 110, 115, 120 and 125 may be utilized by clinicians, nurses, pharmacists, physicians, physical therapists and/or any other suitable health care professionals. The electronic devices 100, 105, 110, 115, 120, 125 may be maintained by a health care institution or a medical entity.

The electronic devices 100, 105, 110, 115, 120, and 125 may receive medical information from and may transmit medical information to each other. The electronic devices 100, 105, 110, 115, 120 and 125 may utilize the medical information in part to generate one or more tasks (e.g., health care tasks) for one or more patients.

It should be pointed out that although FIG. 1 shows six electronic devices 100, 105, 110, 115, 120 and 125 any suitable number of electronic devices 100, 105, 110, 115, 120 and 125 may be part of the system of FIG. 1 without departing from the spirit and scope of the invention.

### Communication Device

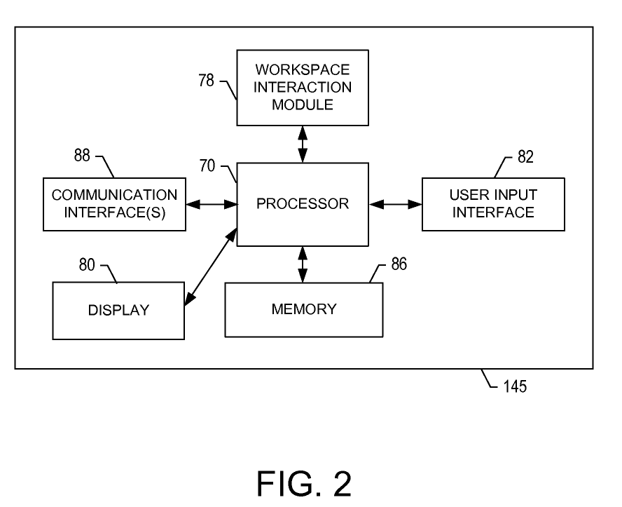

FIG. 2 illustrates a block diagram of a communication device according to an exemplary embodiment of the invention. The communication device 145 is capable of operating as any of electronic devices 100, 105, 110, 115, 120 and 125. In this regard, the electronic devices 100, 105, 110, 115, 120 and 125 may comprise the elements of the communication device 145. The communication device 145 includes various means for performing one or more functions in accordance with exemplary embodiments of the invention, including those more particularly shown and described herein. It should be understood, however, that the communication device 145 may include alternative means for performing one or more like functions, without departing from the spirit and scope of the invention. More particularly, for example, as shown in FIG. 2, the communication device 145 may include a processor 70 connected to a memory 86. The memory 86 may comprise volatile and/or non-volatile memory, and typically stores content (e.g., media content, medical information, etc.), data, information or the like.

For example, the memory 86 may store content transmitted from, and/or received by, other communication devices (e.g., electronic devices 100, 105, 110, 115, 120 and 125). In this regard, in one exemplary embodiment, the memory 86 may store data received from various disparate sources. For example, the memory 86 may store medical information received by the communication device 145 from electronic devices of a hospital, a pharmacy, a laboratory, a clinic, or any other suitable medical entities. Additionally, the memory 86 may store task(s) (e.g., health care task(s)) data for one or more patients that are linked to corresponding clinical data of the one or more patients. The tasks may be provided in a workspace area of a user interface and the corresponding patient clinical data may be provided in an adjacent context area of the user interface.

Also for example, the memory 86 may store client applications, instructions, algorithms or the like for execution by the processor 70 to perform steps associated with operation of the communication device 145 in accordance with embodiments of the invention. As explained below, for example, the memory 86 may store one or more client applications such as, for example, software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor 70 may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other communication devices (e.g., for example, electronic devices 100, 105, 110, 115, 120, 125) over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface may support a wired connection with the respective network.

In addition to the communication interface(s), the interface(s) may also include at least one user interface that may include one or more earphones and/or speakers, a display 80 (also referred to herein as screen 80), and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a workspace interaction module 78. The workspace interaction module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the workspace interaction module 78, as described below. In examples in which software is employed, a device or circuitry (e.g., processor 70 in one example) executing the software forms the structure associated with such means. As such, for example, the workspace interaction module 78 may be configured to, among other things, manage one or more tasks (e.g., of a workflow(s)) which may trigger output of corresponding data in an adjacent context area of a user interface shown via a display (e.g., display 80). The workspace interaction module 78 may also automatically save a state of a task(s), data of a workspace area, and/or data of context area, as described more fully below.

### Exemplary System Operation

Exemplary embodiments of the invention may provide an efficient and reliable mechanism for facilitating navigation between tasks (e.g., health care tasks) to enable management of the tasks on behalf of one or more patients and automatically save data during the navigation of the health care tasks.

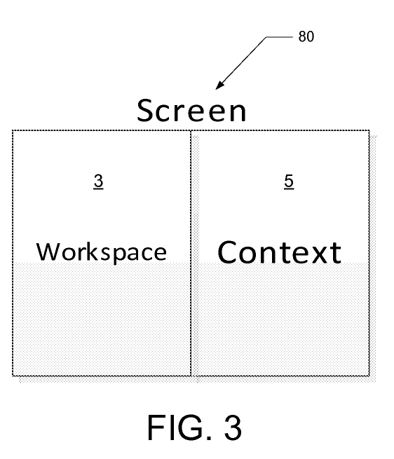

Referring now to FIG. 3, a screen illustrating a workspace area and context area is provided according to an exemplary embodiment. In the example embodiment of FIG. 3, a communication device (e.g., communication device 145) may facilitate user (e.g., a health care clinician) interaction with health care data. As part of the user's day-to-day work, the user may interact with a patient's data (or a view of a population's data) as part of a structured workflow. For example, a health care clinician (e.g., a care manager) may utilize a user input interface (e.g., user input interface 32) of a communication device (e.g., communication device 145) to input or select data for creating one or more tasks (e.g., health care tasks) on behalf of one or more patients. The health care clinician(s) may perform one or more actions to achieve the tasks on behalf of a patient(s).

These created tasks (e.g., health care tasks) may be provided to and shown on a side of a screen 80 (also referred to herein as display 80) in a workspace area 3. As shown in FIG. 3, the screen 80 may have two components. In this regard, one side of the screen 80 may include a workspace area 3 and the other side of the screen 80 may include a context area 5. In some example embodiments, the workspace area 3 may show at least the steps of a task(s) (e.g., health care task(s)) of a workflow(s), or a list of workflows. In an instance in which a user begins or resumes a particular task(s), the screen 80 may include the context area 5 or context view which may display relevant data related to a corresponding patient that is associated with the task(s) for the patient that may be identified or shown in the workspace area 3. By providing a task(s) for the patient in a workspace area 3 and corresponding clinical and demographic information pertaining to the patient in a context area 5 of a single screen 80, a communication device (e.g., communication device 145) may provide a manner in which a health care clinician may complete the task (e.g., a health care task) with ease and efficiency and may enable the clinician to make an informed decision(s) about a patient. In this manner, the screen 80 may provide quick access to a patient's clinical data while enabling a health care clinician to work on one or more tasks related to patient care.

In an example embodiment, the steps of a task of a workflow for completion of the task(s) associated with health of a patient may be displayed in the workspace area 3. As a user such as, for example, a health care clinician moves or progresses through the steps of the task(s) of the workflow, the data in the context area 5 may be changed, by the workspace interaction module 78. The data in the context area 5 may be changed to display the most relevant data pertaining to the step of the task of the workflow in which the user is actively engaged which may be indicated in the workspace area 3. For example, in an instance in which the workspace interaction module 78 performs a medication reconciliation task, the workspace interaction module 78 may trigger the context area 5 to display a patient's list of current medications. In an instance in which a corresponding step of the task denotes reconciling each medication type, the workspace interaction module 78 may enable the context area 5 to display the applicable medication type in response to the user evaluating the step in the workflow denoting reconciliation of each medication type.

On the other hand, in an instance in which the workspace interaction module 78 detects a data change in the context area 5, the workspace interaction module 78 may display information in the workspace area 3 that is relevant to or corresponds to the new data of the context area 5. For purposes of illustration and not of limitation, a provider (e.g., primary care physician) or non-provider (e.g., father) may be added to a patient's care team in the context area 5 and the workspace interaction module 78 may display the new care team member in the workspace area 3 (e.g., as a potential care team member that may be contacted to discuss the patient's care) In this regard, user interactions in one area (e.g., context area 5) of the screen 80 may alter the view in the other area (e.g., workspace area 3) of the screen 80 (e.g., a click in the context area 5 may trigger the workspace interaction module 78 to change the data in the workspace area 3, for example, utilizing a pointer to hover over the context area 5 may refresh the display of the workspace area 3). In one example embodiment, the workspace interaction module 78 may configure the interactions between the workspace area 3 and the context area 5. In this regard, the workspace interaction module 78 may enable the workspace area to configure data such as, for example, a form shown in the context area. The workspace interaction module 78 may trigger configuring of interactions with the context area by changing a form in the workspace area or, for example, by providing a hyperlink in a form of the workspace area that a user may click on which changes the display of the context area.

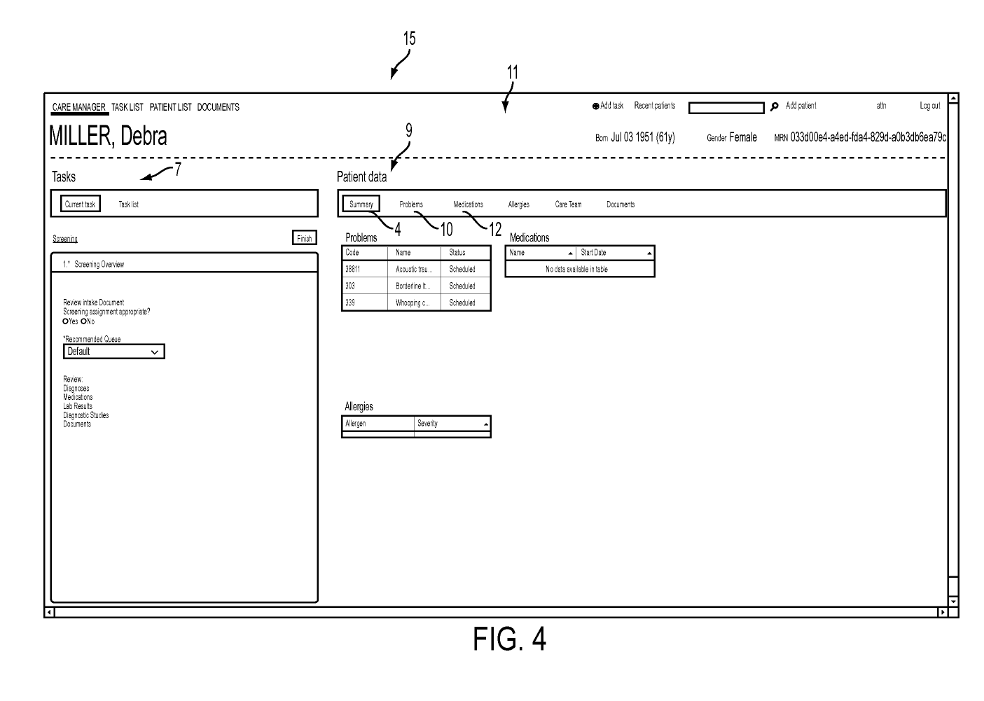

Referring now to FIG. 4, a diagram illustrating a user interface displaying a workspace area and a context area according to an exemplary embodiment is provided. In the example embodiment of FIG. 4, the display 15 (e.g., screen 80) illustrates a user interface 11 that includes a workspace area 7 (e.g., workspace area 3) that may indicate one or more tasks of a workflow for a fictitious patient, Debra Miller, to be performed by a health care clinician such as a care manager. The workspace area 7 provides visible indicia denoting steps for completion of a task (e.g., a health care task) for patient Debra Miller. In the example embodiment of FIG. 4, the steps of the task include screening, review, diagnoses, medications, lab results, diagnostic studies and documents. These steps are included for purposes of illustration and not of limitation and as such other steps of one or more tasks may be utilized by the exemplary embodiments without departing from the spirit and scope of the invention.

In the example embodiment of FIG. 4, the workspace area 7 illustrates that the care manager is currently evaluating the screening task and is considering a screening overview for patient Debra Miller. In the screening overview step, the workspace interaction module 78 may provide visible indicia associated with one or more questions pertaining to screening with respect to patient Debra Miller. In this regard, the workspace area 7 may include visible indicia indicating questions asking the care manager whether to review an intake document and whether a screening assignment is appropriate. The workspace area 7 may also include visible indicia enabling the care manager to select a recommended queue for the screening overview step.

The workspace interaction module 78 may also include a context area 9 in the user interface 11. In the example embodiment of FIG. 4, the workspace interaction module 78 may provide the context area 9 adjacent to the workspace area 7 in which the context area 9 includes patient data (e.g., patient clinical data) pertaining to patient Debra Miller. The context area 9 provides visible indicia indicating a summary of patient data for patient Debra Miller. The summary information of the context area 9 may be associated with a summary tab (e.g., summary tab 4) and may be related to or linked to at least some of the items of data of the screening overview step shown in the workspace area 7. In the example embodiment of FIG. 4, the summary information of the context area 9 includes problems, medications and allergies associated with patient Debra Miller. However, the summary information may include additional information without departing from the spirit and scope of the invention. By visibly indicating the current step (e.g., screening overview) of a task being worked on by the care manager on one side of a user interface 11 in a workspace area 7 and corresponding patient data on the other side of the user interface 11 in a context area 9, the care manager may be able to utilize this information to make better decisions about the health of patient Debra Miller in this example embodiment.

For purposes of illustration and not of limitation, consider an example in which the care manager evaluated claims information for patient Debra Miller and determined that Debra Miller was taking a drug such as captopril. In this regard, the care manager may utilize a user input interface (e.g., user input interface 82) to input data in the workspace area 7 specifying that the patient Debra Miller is taking captopril and in response to receipt of the indication the workspace interaction module 78 may (e.g., automatically) trigger the context area 9 to visibly indicate the list of medications that patient Debra Miller is currently prescribed in the medications section of the summary. In this manner, the care manager may be able to reconcile any medication discrepancies for patient Debra Miller. For example, by evaluating the medications, the care manager may determine that patient Debra Miller was prescribed enalapril instead of captopril and that patient Debra Miller should not take captopril.

In another example embodiment, in an instance in which the care manager utilizes a user input interface to add a medication(s) for patient Debra Miller to the workspace area 7, the workspace interaction module 78 may detect the added medication(s) and may automatically change or update the visible indicia of the context area 9 to show medication data (e.g., prescriptions) for patient Debra Miller associated with a medication tab (e.g., medication tab 12).

In another example embodiment, the workspace interaction module 78 may automatically change the visible indicia of the context area 9 in response to receipt of an indication of a selection of another step of the task. In this regard, for purposes of illustration and not of limitation, in an instance in which a care manager utilizes a user input interface (e.g., user input interface 82) to select the diagnosis step, the workspace interaction module 78 may automatically trigger display of data associated with the problems tab 10. In another example, for purposes of illustration and not of limitation, in response to receipt of an indication of a selection of the medication step of the task, the workstation interaction module 78 may automatically trigger display of medication data (e.g., medication reconciliation data) associated with the medications tab 12 in a context area of a user interface.

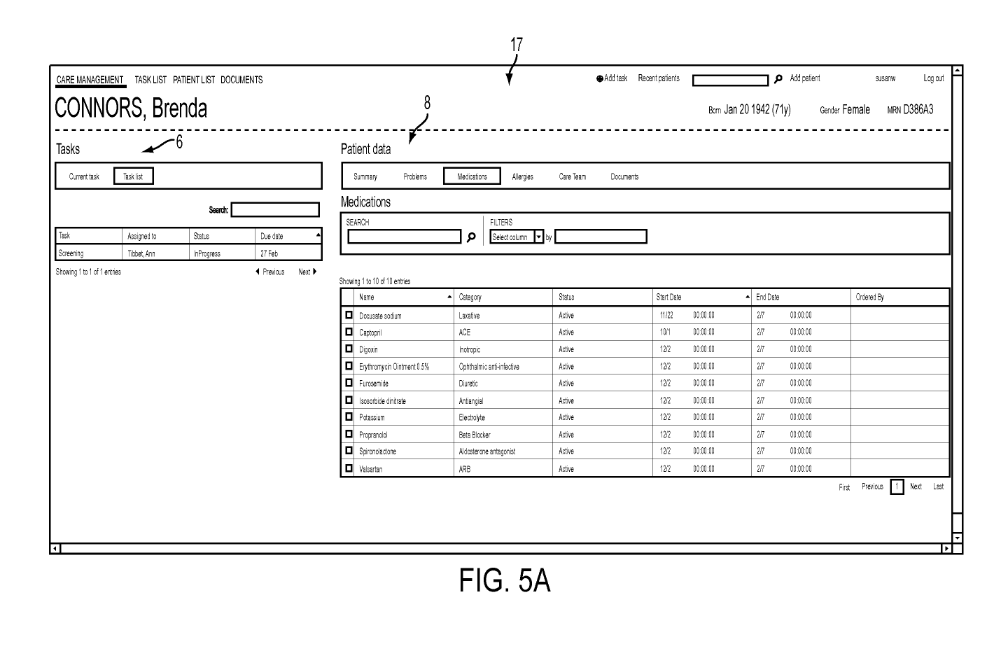

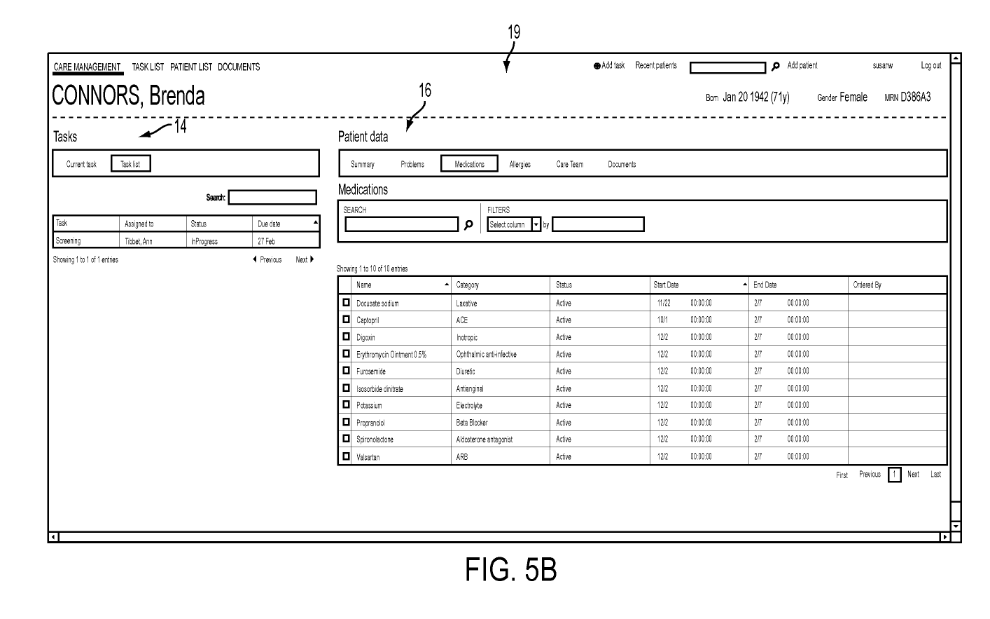

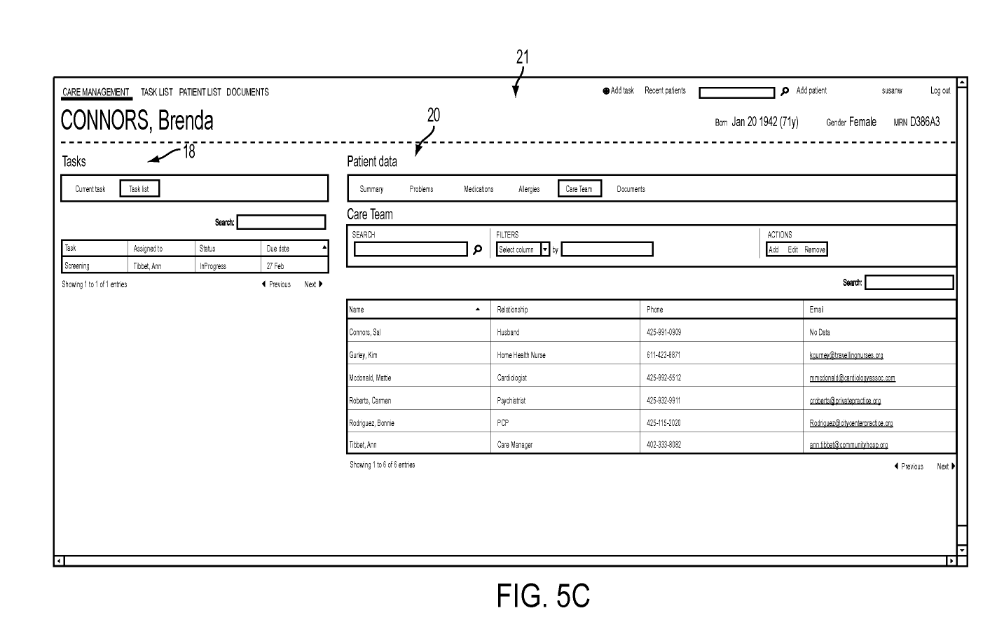

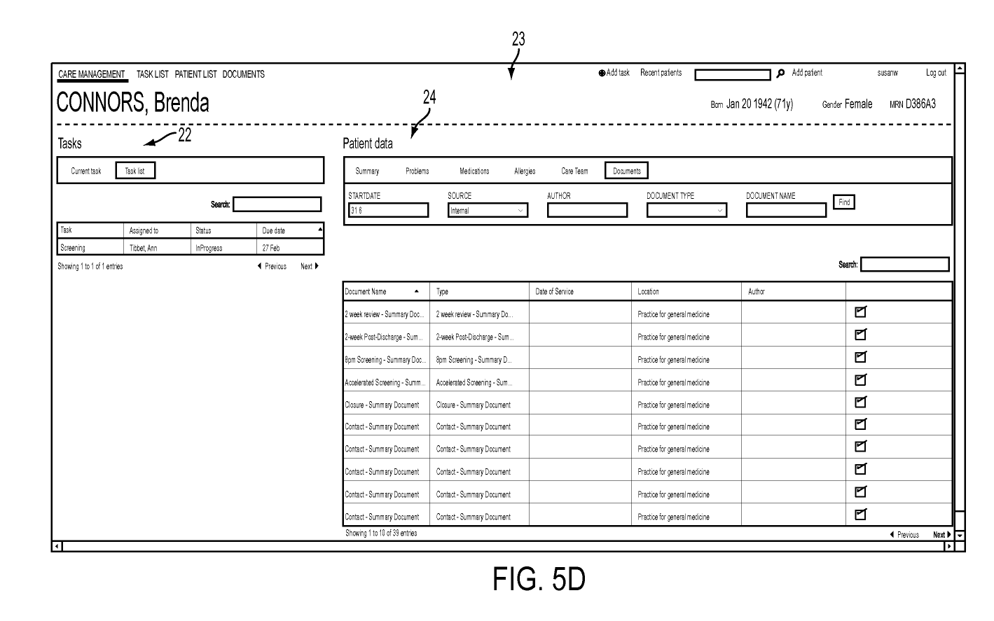

Referring now to FIGS. 5A-5D, diagrams illustrating user interfaces according to an exemplary embodiment are provided. FIGS. 5A-5D illustrate user interfaces generated by the workspace interaction module 78 that includes visible indicia indicating that a care manager such as Ann Tibbett, another fictitious person, is currently performing a screening task for patient Brenda Connors, a fictitious person. In FIG. 5A, the user interface 17 indicates in the workspace area 6 that the screening task is currently in progress by care manager Ann Tibbet and that corresponding clinical data associated with problems for patient Brenda Connors is indicated in the context area 8 of the user interface 17. In FIG. 5B, the user interface 19 indicates in the workspace area 14 that the screening task is currently in progress by care manager Ann Tibbet and that corresponding clinical data associated with medications for patient Brenda Connors is indicated in the context area 16 of the user interface 19. The context area 16 indicates active medications that are prescribed to patient Brenda Connors. In an alternative example embodiment, in an instance in which the care manager Ann Tibbet determines that patient Brenda Connors is no longer taking a medication(s) identified in the content area 16, the care manager Ann Tibbet may utilize a user input interface (e.g., user input interface 82) to remove the medication(s) that the patient is no longer taking from the medication list of the context area 16.

In FIG. 5C, the user interface 21 indicates in the workspace area 18 that the screening task is currently in progress by care manager Ann Tibbet and specifies the care team for patient Brenda Connors indicated in the context area 20 of the user interface 21. In FIG. 5D, the user interface 23 indicates in the workspace area 22 that the screening task is currently in progress by care manager Ann Tibbet and specifies documents corresponding to patient Brenda Connors indicated in the context area 24 of the user interface 23.

In an example embodiment, the workspace interaction module 78 may automatically save the state of a workspace area and/or a context area in a pencil-state without requiring any additional user action. The workspace interaction module 78 may automatically save the state of a workspace area and/or context area in an instance in which a user (e.g., a health care clinician (e.g., a care manager)) (1) navigates during an in-progress task(s) to another task(s) (e.g., another workflow(s)), (2) a user's login times out, (3) a user changes to another application(s), form(s) or the like, (3) a user changes context to another patient(s) or some other data, when the user logs out of a system, or (4) for any other suitable reasons such as, for example, closing a workspace area, a context area, a user interface or a browser. Additionally, the workspace interaction module 78 may automatically save the state of a workspace area and/or a context area periodically (e.g., every two seconds or some other time period).

To save the state and corresponding data, the workspace interaction module 78 may record or save any data that the user has entered in a workspace area (e.g., workspace area 3), information in a context area (e.g., context area 5), any history of actions and any other suitable data. For purposes of illustration and not of limitation, in an instance in which a user is inputting data in a workspace area for a step of a task but switches to another step(s), application(s), form(s) or the like before completing the step of the task, the workspace interaction module 78 may automatically save the workspace area without user intervention. As such, in an instance in which the user returns to the step of the task the workspace interaction module 78 may retrieve the saved state from a memory (e.g., memory 86) and present the saved state to the workspace area of a user interface. In this manner, the user may take action on a task at the step in which progress was previously stopped or interrupted.

In an example embodiment, the workspace interaction module 78 may detect or trace the origin of data added via pencil state. In this regard, the workspace interaction module 78 may indicate an origin of a piece of data by specifying where the data came from (e.g., a workspace area, a context area). For example, in an instance in which a new medication was added through a workspace area such as, for example, a form of a workspace area and is in pencil state, an instance of the form, its associated task, and the workflow may each be captured and indicated by the workspace interaction module 78.

In some example embodiments, clinical data remaining in a pencil state may become stale or irrelevant upon the expiration of a predetermined time period (e.g., 48 hours, 72 hours, etc.). As such, the workspace interaction module 78 may detect the expiration of clinical data in response to the predetermined time period elapsing for data saved in a pencil state and may provide one or more messages to a user (e.g., a health care clinician) informing the user that the clinical data expired. In this regard, the workspace interaction module 78 may include data in the message(s) requesting input from the user indicating whether to delete or remove the clinical data from a memory (e.g., memory 86) or continue to save the clinical data until expiration of another predetermined time period.

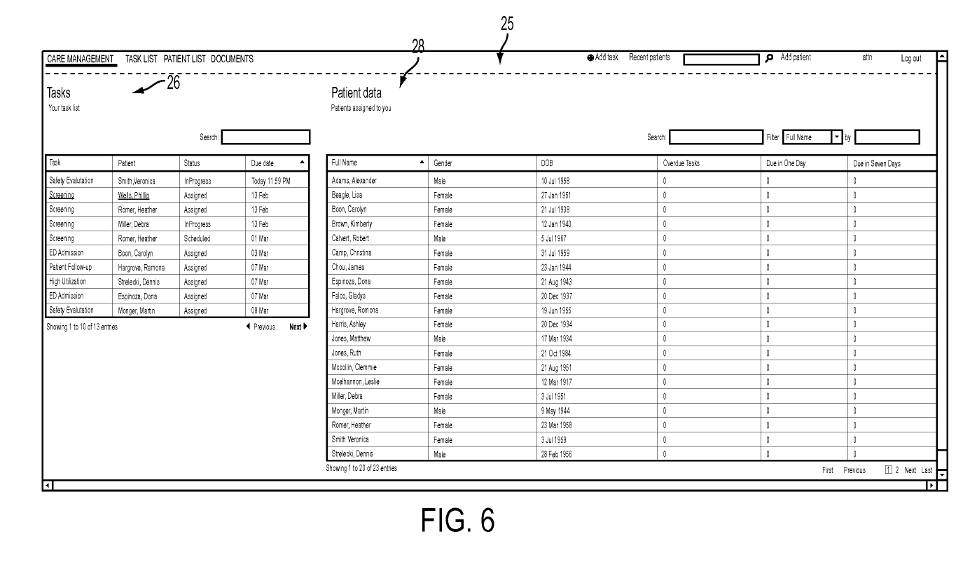

Referring now to FIG. 6, a diagram illustrating a user interface according to an exemplary embodiment is provided. The user interface 25, generated by the workspace interaction module 78, denotes an instance in which the workspace interaction module 78 saved data in a pencil-state. In the example embodiment of FIG. 6, the workspace interaction module 78 detected an instance in which a user began filling out a screening form(s) in a workspace area 26 and exited or closed the screening form(s) without saving. In this regard, the user interface 25 includes visible indicia indicating that the workstation interaction module 78 saved the state of the form(s) in the workspace area 26 and upon reopening the workspace form the data is retrieved and restored in the workspace form by the workstation interaction module 78, For instance, the user interface 25 indicates that the screening task for patient Debra Miller was saved and is in progress. The context area 28 includes visible indicia denoting the patients assigned to a care manager (e.g., Ann Tibbet).

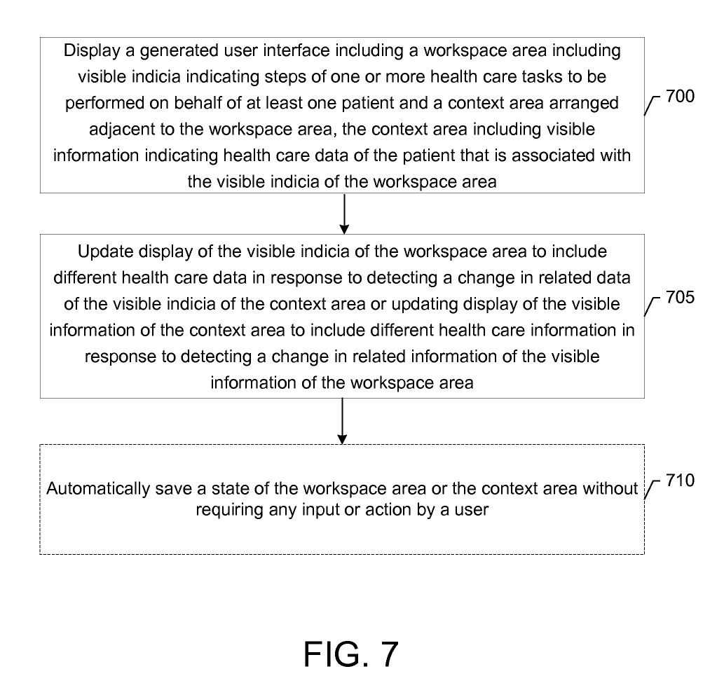

Referring now to FIG. 7, an exemplary method for managing one or more health care workflow interactions with a saved state is provided according to an exemplary embodiment. At operation 700, an apparatus (e.g., communication device 145) may display a generated user interface (e.g., user interface 11) including a workspace area (e.g., workspace area 7) including visible indicia indicating steps of one or more health care tasks to be performed on behalf of at least one patient (e.g., patient Debra Miller) and a context area (e.g., context area 9) arranged adjacent to the workspace area (e.g., workspace area 7). The context area may include visible information (e.g., patient summary information) indicating health care data of the patient that is associated with the visible indicia (e.g., screening information corresponding to a step of a task) of the workspace area.

At operation 705, the apparatus (e.g., communication device 145) may update display of the visible indicia of the workspace area (e.g., workspace area 7) to include different health care data in response to detecting a change in related data of the visible indicia of the context area (e.g., context area 9). Alternatively, the apparatus may update display of the visible information of the context area (e.g., context area 9) to include different health care information (e.g., data indicating active medications of a patient) in response to detecting a change in related information (e.g., input of new medication data for the patient) of the visible information of the workspace area (e.g., workspace area 7). Optionally, at operation 710, the apparatus (e.g., communication device 145) may automatically save a state of the workspace area or the context area without requiring any input or action by a user (e.g., health care clinician).

It should be pointed out that FIG. 7 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, workspace interaction module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 7 above may comprise a processor (e.g., the processor 70, the workspace interaction module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the workspace interaction module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for displaying a user interface, the method comprising:
a display control function executed by a processor, the display control function comprising:
displaying a generated user interface comprising a workspace area comprising visible indicia indicating a plurality of steps of health care tasks in a workflow to be performed in order on behalf of at least one patient and a context area arranged adjacent to the workspace area, the context area comprising visible information indicating health care data of the patient that is associated with the visible indicia of the workspace area; and
updating display of the visible indicia of the workspace area to include different health care data in response to detecting a change in related data of the visible indicia of the context area or updating display of the visible information of the context area to include different health care information in response to detecting a change in related information of the visible information of the workspace area, the detected change being made by inputting at a user input interface.

2. The method of claim 1,
wherein the display control function displays a step, among the steps, of a task that a health care clinician is currently in the process of performing and
displays content relevant to the step in the visible information of the context area while the health care clinician performs the step.

3. The method of claim 2,
wherein the display control function updates display of the visible information of the context area by changing one or more items of data of the visible information of the context area in response to detecting that the health care clinician progressed from performing the step to a different step of the task indicated in the workspace area to enable display of the changed items of data in the context area, the changed items of data in the context area are related to health care content associated with the different step displayed in the workspace area.

4. The method of claim 1,
wherein the display control function updates display of the visible indicia of the workspace area by changing the display of the workspace area in response to detecting one or more interactions of a health care clinician with data of the visible information of the context area.

5. The method of claim 1,
wherein the display control function updates display of the visible information of the context area by changing the display of the context area in response to detecting one or more interactions of a health care clinician with data of the visible indicia of the workspace area.

6. The method of claim 1, further comprising:
a saving control function executed by a processor, the saving control function comprising automatically saving a state of the workspace area or the context area without requiring any input or action by a health care clinician.

7. The method of claim 6, wherein the automatically saved state is saved in a memory in response to at least one of detecting navigation between different tasks or health care workflows, detecting a login time for the health care clinician expiring, detecting a change from one application to another application in the workspace area or the context area, detecting a change in consideration from the patient to another patient, closing the workspace area or the context area, or detecting the expiration of a predetermined time period.

8. The method of claim 6, wherein automatically saving the state comprises saving information associated with a step of a task being performed by the health care clinician such that when the task is subsequently reopened, the task is displayed in the workspace area in the saved state even in an instance in which the step or the task is incomplete.

9. An apparatus comprising at least one processor and at least one memory including computer program code, the at least one memory and the computer program code configured to, with the processor, cause the apparatus to at least:
display a generated user interface comprising a workspace area comprising visible indicia indicating a plurality of steps of health care tasks in a workflow to be performed in order on behalf of at least one patient and a context area arranged adjacent to the workspace area, the context area comprising visible information indicating health care data of the patient that is associated with the visible indicia of the workspace area; and
update display of the visible indicia of the workspace area to include different health care data in response to detecting a change in related data of the visible indicia of the context area or updating display of the visible information of the context area to include different health care information in response to detecting a change in related information of the visible information of the workspace area, the detected change being made by inputting at a user input interface.

10. The apparatus of claim 9, wherein the memory and computer program code are further configured to, with the processor, cause the apparatus to:
display a step, among the steps, of a task that a health care clinician is currently in the process of performing; and
display content relevant to the step in the visible information of the context area while the health care clinician performs the step.

11. The apparatus of claim 10, wherein the memory and computer program code are further configured to, with the processor, cause the apparatus to:
changing one or more items of data of the visible information of the context area in response to detecting that the health care clinician progressed from performing the step to a different step of the task indicated in the workspace area to enable display of the changed items of data in the context area, the changed items of data in the context area are related to health care content associated with the different step displayed in the workspace area.

12. The apparatus of claim 9, wherein the memory and computer program code are further configured to, with the processor, cause the apparatus to:
change the display of the workspace area in response to detecting one or more interactions of a health care clinician with data of the visible information of the context area.

13. The apparatus of claim 9, wherein the memory and computer program code are further configured to, with the processor, cause the apparatus to:
change the display of the context area in response to detecting one or more interactions of a health care clinician with data of the visible indicia of the workspace area.

14. The apparatus of claim 9, wherein the memory and computer program code are further configured to, with the processor, cause the apparatus to:
automatically save a state of the workspace area or the context area without requiring any input or action by a health care clinician.

15. The apparatus of claim 14, wherein the memory and computer program code are further configured to, with the processor, cause the apparatus to:
automatically save the state by saving the state in the memory in response to at least one of detecting navigation between different tasks or health care workflows, detecting a login time for the health care clinician expiring, detecting a change from one application to another application in the workspace area or the context area, detecting a change in consideration from the patient to another patient, closing the workspace area or the context area, or detecting the expiration of a predetermined time period.

16. The apparatus of claim 14, wherein the memory and computer program code are further configured to, with the processor, cause the apparatus to:
automatically save the state by saving information associated with a step of a task being performed by the health care clinician such that when the task is subsequently reopened, the task is displayed in the workspace area in the saved state even in an instance in which the step or the task is incomplete.

17. A computer program product comprising at least one non-transitory computer-readable storage medium having computer-executable program code instructions stored therein, the computer executable program code instructions comprising:
program code instructions configured to display a generated user interface comprising a workspace area comprising visible indicia indicating a plurality of steps of health care tasks in a workflow to be performed in order on behalf of at least one patient and a context area arranged adjacent to the workspace area, the context area comprising visible information indicating health care data of the patient that is associated with the visible indicia of the workspace area; and
program code instructions configured to update display of the visible indicia of the workspace area to include different health care data in response to detecting a change in related data of the visible indicia of the context area or updating display of the visible information of the context area to include different health care information in response to detecting a change in related information of the visible information of the workspace area, the detected change being made by inputting at a user input interface.

18. The computer program product of claim 17, further comprising:
program code instructions configured to display a step, among the steps, of a task that a health care clinician is currently in the process of performing; and
program code instructions configured to display content relevant to the step in the visible information of the context area while the health care clinician performs the step.

19. The computer program product of claim 18, further comprising:
program code instructions configured to change one or more items of data of the visible information of the context area in response to detecting that the health care clinician progressed from performing the step to a different step of the task indicated in the workspace area to enable display of the changed items of data in the context area, the changed items of data in the context area are related to health care content associated with the different step displayed in the workspace area.

20. The computer program product of claim 17, further comprising:
program code instructions configured to change the display of the workspace area in response to detecting one or more interactions of a health care clinician with data of the visible information of the context area.
